(19) United States
(12) Patent Application Publication
(10) Pub. No.: US 2022/0197101 A1
(43) Pub. Date: Jun. 23, 2022

(54) NON-INTRUSIVE DATA COLLECTION FOR NON-LIGHT-EMITTING VARIABLE TRANSMISSION DEVICES AND A METHOD OF USING THE SAME

(71) Applicant: SAGE ELECTROCHROMICS, INC., Faribault, MN (US)

(72) Inventors: Dallas AKRE, Lonsdale, MN (US); Zachary VOLLEN, Eagan, MN (US)

(21) Appl. No.: 17/645,145

(22) Filed: Dec. 20, 2021

Related U.S. Application Data
(60) Provisional application No. 63/129,225, filed on Dec. 22, 2020.

(51) Int. Cl. G02F 1/163; G02F 1/1523

(52) U.S. Cl. CPC G02F 1/163; G02F 1/1523

(57) ABSTRACT

A system can include a processor couple to the one or more non-light emitting, variable transmission devices. The processor can be configured to receive a first data from the one or more non-light emitting, variable transmission devices without sending a request, send a first request to collect a second data from the devices, determine whether either the second data is received or a first time-out frame is reached, if the second data is received before the first-time out frame is reached, then send a second request to collect a third data from the one or more non-light emitting, variable transmission devices, and if the first-time out frame is reached before the second data is received, then requeue the first request for the second data and send the second request to collect the third data from the one or more non-light emitting, variable transmission devices.

### CROSS-REFERENCE TO RELATED APPLICATION(S)

This application claims priority under 35 U.S.C. § 119(e) to U.S. Provisional Application No. 63/129,225, entitled “NON-INTRUSIVE DATA COLLECTION FOR NON-LIGHT-EMITTING VARIABLE TRANSMISSION DEVICES AND A METHOD OF USING THE SAME,” by Dallas AKRE et al., filed Dec. 22, 2020, which is assigned to the current assignee hereof and incorporated herein by reference in its entirety.

### FIELD OF THE DISCLOSURE

The present disclosure is directed to systems that include non-light-emitting variable transmission devices, and more specifically to data collection for non-light-emitting variable transmission devices and methods of using the same.

### BACKGROUND

A non-light-emitting variable transmission device can reduce glare and the amount of sunlight entering a room or passenger compartment. Conventionally, an electrochromic device can be at a particular transmission state. For example, the electrochromic device may be set to a certain tint level (i.e. a percentage of light transmission through the electrochromic device), such as full tint (e.g. 0% transmission level), full clear (e.g. 63%+/−10% transmission level).

As the electrochromic device continues to switch between tint and clear states, parameters that control the device too can change with use. For instance, variations in the voltages needed, the resistance within the device, or the power necessary to run multiple devices can change from a first point in time when the device is installed to months later when the device has been operational on a continuous basis. Knowing and understanding the changes can help optimize performance of the device. However, running diagnostics on the device can be costly, interrupt day to day operations of the device, and can inhibit the purpose of the device. As such, a need exists for a better control strategy for an electrochromic device.

### BRIEF DESCRIPTION OF THE DRAWINGS

Embodiments are illustrated by way of example and are not limited in the accompanying figures.

FIG. 1 includes a schematic depiction of a system for controlling a set of non-light-emitting, variable transmission devices in accordance with an embodiment.

FIG. 2 includes a flow diagram for operating the system of FIG. 1.

FIG. 3 includes an illustration of a cross-sectional of a non-light emitting, variable transmission device, according to one embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The terms “normal operation” and “normal operating state” refer to conditions under which an electrical component or device is designed to operate. The conditions may be obtained from a data sheet or other information regarding voltages, currents, capacitances, resistances, or other electrical parameters. Thus, normal operation does not include operating an electrical component or device well beyond its design limits.

The term “color rendering”, when referring to an electrical device, is intended to refer to the amount of light transmission permitted through an electrochromic window for a space to keep the color within the space within a wavelength of between 680 nm and 720 nm.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

A system can include one or more non-light-emitting, variable transmission devices; and a processor coupled and configured to provide control signals to the non-light-emitting, variable transmission devices.

The systems and methods are better understood after reading the specification in conjunction with the figures. System architectures are described and illustrated, followed by an exemplary construction of a non-light-emitting, variable transmission device, and a method of controlling the system. The embodiments described are illustrative and not meant to limit the scope of the present invention, as defined by the appended claims.

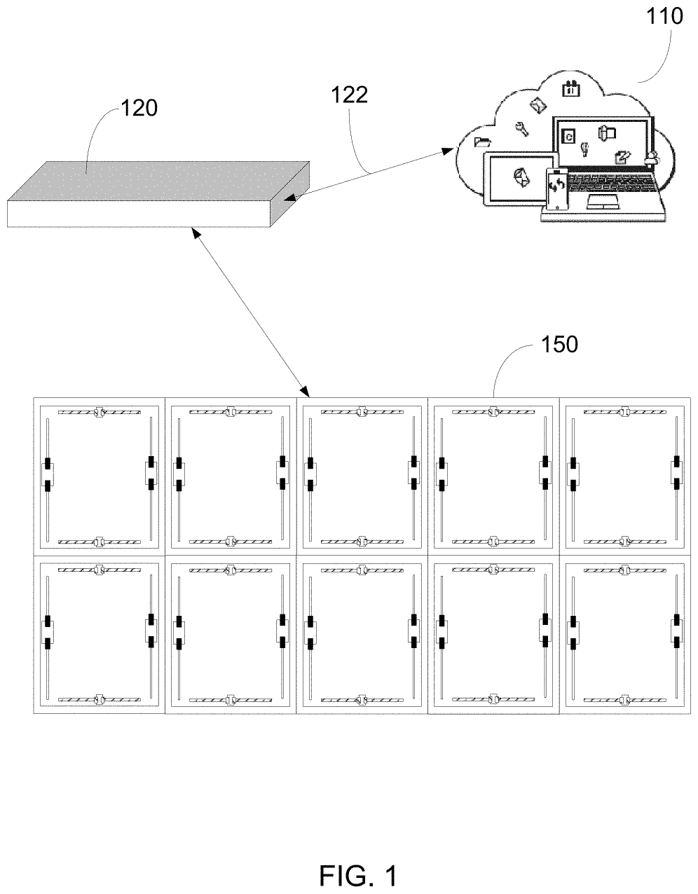

Referring to FIG. 1, a system for controlling a set of non-light-emitting, variable transmission devices is illustrated and is generally designated 100. The system 100 can include logic to control the operation of the control the heating ventilation air condition (HVAC) system of the building, interior lighting, exterior lighting, emergency lighting, fire suppression equipment, elevators, escalators, alarms, security cameras, access doors, another suitable component or sub-system of the building, or any combination thereof. The logic for the control management system 110 can be in the form of hardware, software, or firmware. In a particular embodiment, the logic can be within a computing device such as a desk top computer, a laptop computer, a tablet computer, a smartphone, some other computing device, or a combination thereof. The logic may be in a separate location from the non-light-emitting, variable transmission devices. In an embodiment, the logic may be stored in a field programmable gate array (FPGA), an application-specific integrated circuit (ASIC), a hard drive, a solid state drive, or another persistent memory. In an embodiment, the control management system 110 may include a processor that can execute instructions stored in memory within the control management system 110 or received from an external source.

The system 100 can be used to regulate the transmission of an insulated glazing unit (IGU) installed as part of architectural glass along a wall of a building or a skylight, or within a vehicle as well as to evaluate the performance of the one or more IGU's. As depicted, the system 100 can include a processor 110, a router 120, and a frame panel 150.

As illustrated in FIG. 1, the router 120 can be connected to the processor system 110 via a control link 122. The control link 122 can be a wired connection, such as in a local area network or Ethernet network. The control link 122 can be a wireless connection. In an embodiment, the control link 122 can use a wireless local area network connection operating according to one or more of the standards within the IEEE 802.11 (WiFi) family of standards. In a particular aspect, the wireless connections can operate within the 2.4 GHz ISM radio band, within the 5.0 GHz ISM radio band, or a combination thereof. Regardless of the type of control link 122, the processor 110 can provide control signals to the router 120 via the control link 122. The control signals can be used to control the operation of one or more non-light-emitting variable transmission devices that are indirectly, or directly, connected to the router 120. In another embodiment, signals from the router 120 can go to the processor 110 via the control link 122. In one embodiment, and as discussed in further detail below, the signals can include data from one or more of the non-light emitting, variable transmission devices within the window frame 150.

As seen in FIG. 1, the window frame panel 150 can include a plurality of non-light-emitting, variable transmission devices. In the embodiment as illustrated, the router may be electrically connected to one or more non-light-emitting, variable transmission devices. In another embodiment, a different number of non-light-emitting, variable transmission devices, a different matrix of the non-light-emitting, variable transmission devices, or both may be used. Each of the non-light-emitting, variable transmission devices may be on separate glazings. In another embodiment, a plurality of non-light-emitting, variable transmission devices can share a glazing. In another embodiment, a pair of glazings in the window frame panel 150 can have different sizes, such glazings can have a different numbers of non-light-emitting, variable transmission devices. After reading this specification, skilled artisans will be able to determine a particular number and organization of non-light-emitting, variable transmission devices for a particular application.

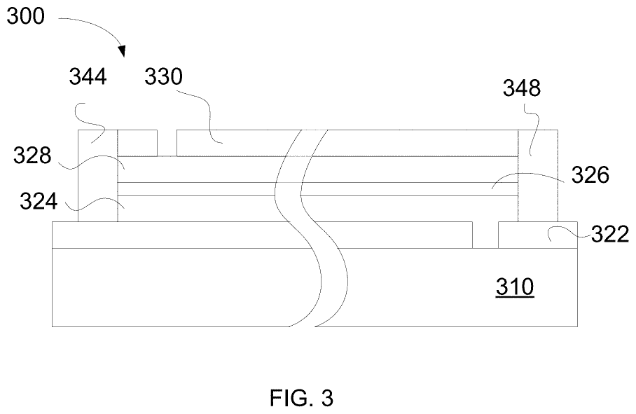

The system can be used with a wide variety of different types of non-light-emitting variable transmission devices, as described in more detail with respect to FIG. 3. The apparatuses and methods can be implemented with switchable devices that affect the transmission of light through a window. Much of the description below addresses embodiments in which the switchable devices are electrochromic devices. In other embodiments, the switchable devices can include suspended particle devices, liquid crystal devices that can include dichroic dye technology, and the like. Thus, the concepts as described herein can be extended to a variety of switchable devices used with windows.

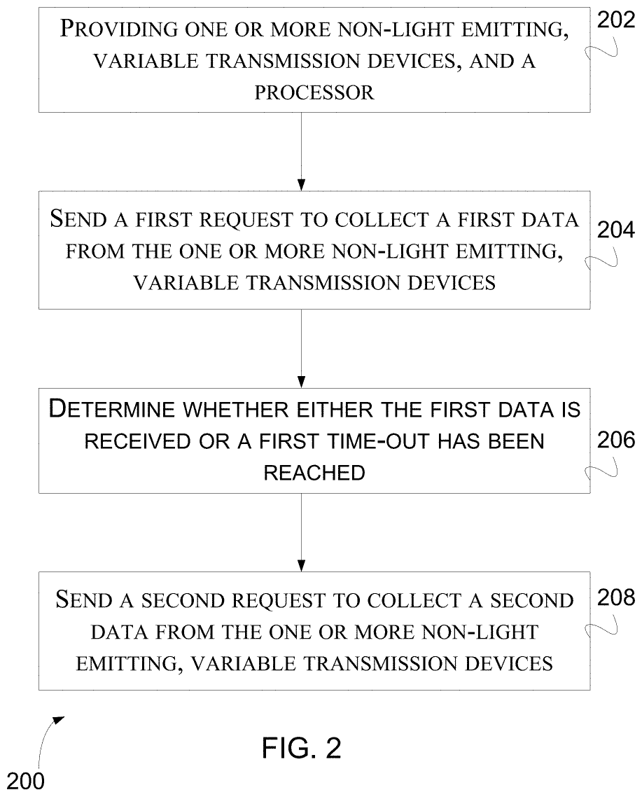

FIG. 2 includes a flow diagram for operating the system 100 of FIG. 1. In one embodiment, the processor 110 can include a memory that is configured to implement a device monitoring and control system for the system 100. The memory can be configured to keep a running log of data types received from the one or more non-light-emitting, variable transmission devices. In one embodiment, the processor 110 can receive data of the normal operation from the one or more non-light emitting, variable transmission devices without having sent a request. The processor 110 can then analyze the data, prioritize the data, and send the data for further processing.

In one embodiment, the processor can evaluate and log the types of data received from the one or more non-light emitting, variable transmission devices. In one embodiment, the processor 110 can evaluate the total message rate for the system. In one embodiment, the total message rate can include the amount of signals going to and coming from the one or more non-light-emitting, variable transmission devices that the system can handle. In one embodiment, the total message rate can include control signals to the one or more non-light emitting, variable transmission devices and performance signals from the one or more non-light emitting, variable transmission devices.

The processor 110 can then determine if a first request for data can be sent based on a threshold amount for sending requests, where the threshold amount is a percentage of the total message rate. In one embodiment, the total message rate is the maximum amount of messages that can be received and sent within a system. In one embodiment, the total message rate can be measured. In another embodiment, the total message rate can be calculated using a model. The first data can include performance information, such as voltage thresholds to switch the device from a clear state to a tint state, reflectance information, lighting and radiation information, information regarding one or more variable characteristics of glass, log information related to manual overrides. In one embodiment, the threshold amount can be set to 95% of the total message rate. For example, if the total message rate is 100 signals/minute, and the threshold amount is 95% then a current message rate of 90 signals/minute would be below the threshold amount. Thus, if the system, and in particular the current message rate, is below 95 signals/minute then a first request for data can be sent from the processor to the one or more non-light emitting, variable transmission devices. In another embodiment, the threshold amount can be set to 90% of the total message rate, such as 85% of the total message rate, or 80% of the total message rate, or 75% of the total message rate, or 70% of the total message rate, or 65% of the total message rate.

In another embodiment, and as seen in operation 204, the processor can send a first request to collect a first data from the one or more non-light emitting, variable transmission devices without first determining the current message rate. Instead, the processor can send a first request to collect a first data from the one or more non-light emitting, variable transmission devices. Then, as seen in operation 206, the processor can determine whether either the first data is received or a first-time out frame is reached. In such an embodiment, the system is self-limiting to ensure that the request for data collection does not interfere with the performance of the one or more devices. In one embodiment, the first-time out frame is 10 minutes, such as 8 minutes, or 5 minutes, or 3 minutes, or 1 minute. In one embodiment, if the first request for a first data set is sent after the current message rate is determined to be below the set threshold amount and the data is received, then a second request for a second data set can be sent. In another embodiment, if the first request for a first data set is sent after the current message rate is determined to be below the set threshold amount and the data is not received before the first time-out range is received, then the first data can be requeued and a second current message rate calculation can be performed to determine if the second current message rate is below the threshold amount. If the second current message rate is below the threshold amount, a second request for a second data set can be sent. If the second current message rate is above the threshold amount, the system does not send any more requests until the current message rate is below the threshold amount.

In one embodiment, if the first data is received without first determining the message rate and the threshold amount and before the first-time out frame is reached, then send a second request to collect a second data from the one or more non-light emitting, variable transmission devices is sent, as seen in operation 208. In a second embodiment, if the first-time out frame is reached before the first data is received, then the first request for the first data is requeued and a second request to collect a second data from the one or more non-light emitting, variable transmission devices is sent, as seen in operation 208. In another embodiment, if the first-time out frame is reached before the first data is received, then the first request for the first data is requeued and the current message rate can be determined. If the current message rate is below the threshold amount, a second request for a second data set can be sent. If the current message rate is above the threshold amount, the system does not send any more requests until the current message rate is below the threshold amount.

In another embodiment, the processor can send a first request to collect a first data from the one or more non-light emitting, variable transmission devices after first determining the message rate or threshold amount. In one embodiment, the threshold amount has not been reached and a first request is sent. The operations can proceed as seen above by then determine whether either the first data is received or a first-time out frame is reached and so on. In one embodiment, the processor can requeue a request until the request is fulfilled. For example, if a first request is not fulfilled, the processor can send a second request different from the first request and requeue the first request. If the second request is fulfilled, the processor can move on to an unfulfilled request, which may include the first request. The processor may continue until all requests are fulfilled. By requeing a request, the processor ensures that the priority is control of the non-light emitting, variable transmission devices and that requests for data do not adversely affect the performance of the devices. The data that is collected can subsequently be analyzed and used to adjust and control the performance of the one or more non-light-emitting, variable transmission devices.

The description with respect to FIG. 3 provides exemplary embodiments of a glazing that includes a glass substrate and a non-light-emitting variable transmission device disposed thereon. The embodiment as described with respect to 3 is not meant to limit the scope of the concepts as described herein. In the description below, a non-light-emitting variable transmission device will be described as operating with voltages on bus bars being in a range of 0 V to 3 V. Such description is used to simplify concepts as described herein. Other voltage may be used with the non-light-emitting variable transmission device or if the composition or thicknesses of layers within an electrochromic stack are changed. The voltages on bus bars may both be positive (1 V to 4 V), both negative (−5 V to −2 V), or a combination of negative and positive voltages (−1 V to 2 V), as the voltage difference between bus bars are more important than the actual voltages. Furthermore, the voltage difference between the bus bars may be less than or greater than 3 V. After reading this specification, skilled artisans will be able to determine voltage differences for different operating modes to meet the needs or desires for a particular application. The embodiments are exemplary and not intended to limit the scope of the appended claims.

In accordance with the present disclosure, FIG. 3 illustrates a cross-section view of a partially fabricated electrochemical device 300 having an improved film structure. For purposes of illustrative clarity, the electrochemical device 300 is a variable transmission device. In one embodiment, the electrochemical device 300 can be an electrochromic device. In another embodiment, the electrochemical device 300 can be a thin-film battery. However, it will be recognized that the present disclosure is similarly applicable to other types of scribed electroactive devices, electrochemical devices, as well as other electrochromic devices with different stacks or film structures (e.g., additional layers). With regard to the electrochemical device 300 of FIG. 3, the device 300 may include a substrate 310 and a stack overlying the substrate 310. The stack may include a first transparent conductor layer 322, a cathodic electrochemical layer 324, an anodic electrochemical layer 328, and a second transparent conductor layer 330. In one embodiment, the stack may also include an ion conducting layer 326 between the cathodic electrochemical layer 324 and the anodic electrochemical layer 328.

In an embodiment, the substrate 310 can include a glass substrate, a sapphire substrate, an aluminum oxynitride substrate, or a spinel substrate. In another embodiment, the substrate 310 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 310 may or may not be flexible. In a particular embodiment, the substrate 310 can be float glass or a borosilicate glass and have a thickness in a range of 0.5 mm to 12 mm thick. The substrate 310 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 310 can include ultra-thin glass that is a mineral glass having a thickness in a range of 50 microns to 300 microns. In a particular embodiment, the substrate 310 may be used for many different electrochemical devices being formed and may referred to as a motherboard.

Transparent conductive layers 322 and 330 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 322 and 330 can include gold, silver, copper, nickel, aluminum, or any combination thereof. The transparent conductive layers 322 and 330 can include indium oxide, indium tin oxide, doped indium oxide, tin oxide, doped tin oxide, zinc oxide, doped zinc oxide, ruthenium oxide, doped ruthenium oxide and any combination thereof. The transparent conductive layers 322 and 330 can have a thickness between 10 nm and 600 nm. In one embodiment, the transparent conductive layers 322 and 330 can have a thickness between 200 nm and 500 nm. In one embodiment, the transparent conductive layers 322 and 330 can have a thickness between 320 nm and 460 nm. In one embodiment the first transparent conductive layer 322 can have a thickness between 10 nm and 600 nm. In one embodiment, the second transparent conductive layer 330 can have a thickness between 80 nm and 600 nm.

The layers 324 and 328 can be electrode layers, wherein one of the layers may be a cathodic electrochemical layer, and the other of the layers may be an anodic electrochromic layer (also referred to as a counter electrode layer). In one embodiment, the cathodic electrochemical layer 324 is an electrochromic layer. The cathodic electrochemical layer 324 can include an inorganic metal oxide material, such as WO₃, V₂O₅, MoO₃, Nb₂O₅, TiO₂, CuO, Ni₂O₃, NiO, Ir₂O₃, Cr₂O₃, CO₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 324 can have a thickness between 100 nm to 400 nm. In one embodiment, the cathodic electrochemical layer 324 can have a thickness between 350 nm to 390 nm. The cathodic electrochemical layer 324 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The anodic electrochromic layer 328 can include any of the materials listed with respect to the cathodic electrochromic layer 324 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the anodic electrochromic layer 328 can have a thickness between 150 nm to 300 nm. In one embodiment, the anodic electrochromic layer 328 can have a thickness between 250 nm to 290 nm.

In another embodiment, the device 300 may include a plurality of layers between the substrate 310 and the first transparent conductive layer 322. In one embodiment, an antireflection layer can be between the substrate 310 and the first transparent conductive layer 322. The antireflection layer can include SiO₂, NbO₂, Nb₂O₅ and can be a thickness between 20 nm to 100 nm. The device 300 may include at least two bus bars with one bus bar 344 electrically connected to the first transparent conductive layer 322 and the second bus bar 348 electrically connected to the second transparent conductive layer 330.

Embodiments as described above can provide benefits over other systems with non-light-emitting, variable transmission devices. The use of remote scene selection and control can help with maintenance of an installed device. The methods as described herein allow all non-light-emitting, variable transmission devices coupled to be controlled individually based on the state information received and prioritization of that state information.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

### Embodiment 1

A system, including: one or more non-light emitting, variable transmission devices; and a processor couple to the one or more non-light emitting, variable transmission devices, where the processor is configured to: receive a first data from the one or more non-light emitting, variable transmission devices without sending a request; send a first request to collect a second data from the one or more non-light emitting, variable transmission devices; determine whether either the second data is received or a first time-out frame is reached; if the second data is received before the first-time out frame is reached, then send a second request to collect a third data from the one or more non-light emitting, variable transmission devices; and if the first-time out frame is reached before the second data is received, then requeue the first request for the second data and send the second request to collect the third data from the one or more non-light emitting, variable transmission devices.

### Embodiment 2

The system of embodiment 1, where the processor is further configured to determine a total message rate for the system, where the total message rate is a maximum number of signals capable of traveling between the processor and the one or more non-light-emitting, variable transmission devices per minute.

### Embodiment 3

The system of embodiment 2, where the processor is further configured to determine a threshold amount, where the threshold amount is 95% of the message rate.

### Embodiment 4

The system of embodiment 3, where the processor is further configured to determine a current message rate, where the current message rate is the amount of signals at a first point in time.

### Embodiment 5

The system of embodiment 4, where the processor sends the first request to collect the second data after the processor determines the current message rate is below the threshold amount.

### Embodiment 6

The system of embodiment 3, where the threshold amount is 90% of the message rate.

### Embodiment 7

The system of embodiment 3, where the threshold amount is 85% of the message rate.

### Embodiment 8

The system of embodiment 1, where the first time-out frame is 10 minutes.

### Embodiment 9

The system of embodiment 1, where the first time-out frame is 1 minute.

### Embodiment 10

The system of embodiment 1, where the processor is further configured to determine whether either the third data is received or a second time-out frame is reached.

### Embodiment 11

The system of embodiment 10, where the second-time out frame is the same as the first-time out frame.

### Embodiment 12

The system of embodiment 10, where the second-time out frame is different from the first-time out frame.

### Embodiment 13

The system of embodiment 10, where the second-time out frame is between 10 minutes, such as 8 minutes, or 5 minutes, or 3 minutes, or 1 minute.

### Embodiment 14

The system of embodiment 1, where each of the one or more non-light emitting, variable transmission devices includes: a substrate; a first transparent conductive layer; a second transparent conductive layer; a cathodic electrochemical layer between the first transparent conductive layer and the second transparent conductive layer; and an anodic electrochemical layer between the first transparent conductive layer and the second transparent conductive layer.

### Embodiment 15

The system of embodiment 14, where the substrate includes glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

### Embodiment 16

The system of embodiment 14, where each of the one or more electrochromic devices further includes an ion conducting layer between the cathodic electrochemical layer and the anodic electrochemical layer.

### Embodiment 17

The system of embodiment 16, where the ion-conducting layer includes lithium, sodium, hydrogen, deuterium, potassium, calcium, barium, strontium, magnesium, oxidized lithium, Li2WO4, tungsten, nickel, lithium carbonate, lithium hydroxide, lithium peroxide, or any combination thereof.

### Embodiment 18

The system of embodiment 14, where the cathodic electrochemical layer includes WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

### Embodiment 19

The system of embodiment 14, where the first transparent conductive layer includes indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

### Embodiment 20

The system of embodiment 14, where the second transparent conductive layer includes indium oxide, indium tin oxide, doped indium oxide, tin oxide, doped tin oxide, zinc oxide, doped zinc oxide, ruthenium oxide, doped ruthenium oxide and any combination thereof.

### Embodiment 21

The system of embodiment 14, where the anodic electrochemical layer includes a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

### Embodiment 22

A method, including: sending a first request to collect a first data from one or more non-light emitting, variable transmission devices; where sending the first request to collect the first data is performed by a processor connected to the one or more non-light emitting variable transmission devices; determining whether either the first data is received or a first time-out frame is reached; if the first data is received before the first-time out frame is reached, then send a second request to collect a second data from the one or more non-light emitting, variable transmission devices; and if the first-time out frame is reached before the first data is received, then requeue the first request for the first data and send the second request to collect the second data from the one or more non-light emitting, variable transmission devices.

### Embodiment 23

A non-transitory computer readable medium containing a program of instructions for controlling one or more non-light-emitting, variable transmission devices, execution of which by a processor causes the steps of: sending a first request to collect a first data from one or more non-light emitting, variable transmission devices; where sending the first request to collect the first data is performed by a processor connected to the one or more non-light emitting variable transmission devices; determining whether either the first data is received or a first time-out frame is reached; if the first data is received before the first-time out frame is reached, then send a second request to collect a second data from the one or more non-light emitting, variable transmission devices; and if the first-time out frame is reached before the first data is received, then requeue the first request for the first data and send the second request to collect the second data from the one or more non-light emitting, variable transmission devices.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A system, comprising:
one or more non-light emitting, variable transmission devices; and
a processor couple to the one or more non-light emitting, variable transmission devices, wherein the processor is configured to:
receive a first data from the one or more non-light emitting, variable transmission devices without sending a request;
send a first request to collect a second data from the one or more non-light emitting, variable transmission devices;
determine whether either the second data is received or a first time-out frame is reached;
if the second data is received before the first-time out frame is reached, then send a second request to collect a third data from the one or more non-light emitting, variable transmission devices; and
if the first-time out frame is reached before the second data is received, then requeue the first request for the second data and send the second request to collect the third data from the one or more non-light emitting, variable transmission devices.

2. The system of claim 1, wherein the processor is further configured to determine a total message rate for the system, wherein the total message rate is a maximum number of signals capable of traveling between the processor and the one or more non-light-emitting, variable transmission devices per minute.

3. The system of claim 2, wherein the processor is further configured to determine a threshold amount, wherein the threshold amount is 95% of the message rate.

4. The system of claim 3, wherein the processor is further configured to determine a current message rate, wherein the current message rate is the amount of signals at a first point in time.

5. The system of claim 4, wherein the processor sends the first request to collect the second data after the processor determines the current message rate is below the threshold amount.

6. The system of claim 3, wherein the threshold amount is 90% of the message rate.

7. The system of claim 3, wherein the threshold amount is 85% of the message rate.

8. The system of claim 1, wherein the first time-out frame is between 1 minute and 10 minutes.

9. The system of claim 1, wherein the processor is further configured to determine whether either the third data is received or a second time-out frame is reached.

10. The system of claim 9, wherein the second-time out frame is the same as the first-time out frame.

11. The system of claim 9, wherein the second-time out frame is different from the first-time out frame.

12. The system of claim 9, wherein the second-time out frame is less than 10 minutes and greater than 10 seconds.

13. The system of claim 1, wherein each of the one or more non-light emitting, variable transmission devices comprises:
a substrate;
a first transparent conductive layer;
a second transparent conductive layer;
a cathodic electrochemical layer between the first transparent conductive layer and the second transparent conductive layer; and
an anodic electrochemical layer between the first transparent conductive layer and the second transparent conductive layer.

14. The system of claim 13, wherein each of the one or more electrochromic devices further comprises an ion conducting layer between the cathodic electrochemical layer and the anodic electrochemical layer.

15. The system of claim 14, wherein the ion-conducting layer comprises lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

16. The system of claim 13, wherein the cathodic electrochemical layer comprises WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

17. The system of claim 13, wherein the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

18. The system of claim 13, wherein the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

19. A method, comprising:
sending a first request to collect a first data from one or more non-light emitting, variable transmission devices; wherein sending the first request to collect the first data is performed by a processor connected to the one or more non-light emitting variable transmission devices;
determining whether either the first data is received or a first time-out frame is reached;
if the first data is received before the first-time out frame is reached, then send a second request to collect a second data from the one or more non-light emitting, variable transmission devices; and
if the first-time out frame is reached before the first data is received, then requeue the first request for the first data and send the second request to collect the second data from the one or more non-light emitting, variable transmission devices.

20. A non-transitory computer readable medium containing a program of instructions for controlling one or more non-light-emitting, variable transmission devices, execution of which by a processor causes the steps of:
sending a first request to collect a first data from one or more non-light emitting, variable transmission devices; wherein sending the first request to collect the first data is performed by a processor connected to the one or more non-light emitting variable transmission devices;
determining whether either the first data is received or a first time-out frame is reached;
if the first data is received before the first-time out frame is reached, then send a second request to collect a second data from the one or more non-light emitting, variable transmission devices; and
if the first-time out frame is reached before the first data is received, then requeue the first request for the first data and send the second request to collect the second data from the one or more non-light emitting, variable transmission devices.
